(19) United States
(12) Patent Application Publication
(10) Pub. No.: US 2001/0046854 A1
(43) Pub. Date: Nov. 29, 2001

(54) METHOD OF REMOTELY UPDATING THE SOFTWARE OF A MOBILE TELEPHONE TERMINAL

(76) Inventors: PASCAL HENRY, PARIS (FR); HERVE THIL, BOULOGNE (FR)

Correspondence Address: SUGHRUE MION ZINN MACPEAK & SEAS PLLC, 2100 PENNSYLVANIA AVENUE NW SUITE 800, WASHINGTON, DC, 200373213

(21) Appl. No.: 09/420,774

(22) Filed: Oct. 19, 1999

(30) Foreign Application Priority Data
Oct. 21, 1998 (FR) 98 13 212

(51) Int. Cl. H04M 3/00

(52) U.S. Cl. 455/419

(57) ABSTRACT

A method is disclosed of updating the software of a GSM or equivalent mobile telephone terminal via a base transceiver station in whose coverage area the terminal is located and using data supplied by a programming platform operating at the level of a server center to which the base transceiver station is connected in a fixed telecommunication network. The terminal is updated by a transparent exchange of SMS or equivalent mobile telephone messages at the initiative of the programming platform and in cooperation with the server center.

### BACKGROUND OF THE INVENTION

1. Field of the Invention

The invention concerns a method of remotely updating the software of a cellular mobile telephone terminal, especially a GSM mobile telephone terminal.

2. Description of the Prior Art

Cellular mobile telephone terminals are conventionally supplied to users already programmed to suit the requirements of the user and choices made by or for the user.

There are various reasons for modifying the programming after a terminal has been delivered to a user, for example to improve the service provided, to update software that may evolve or to add new options or existing options not previously required.

To this end, users were originally asked to take their mobile telephone terminals to a place at which the updating could be done. Nowadays this solution is to be avoided.

Another solution is disclosed in document EP-A-478231, which describes a method of programming a mobile radio terminal using radio signals transmitted by an update server center after the user has switched the terminal to a programming mode. This solution is used in particular to enable a user to obtain codes authorizing specific mobile services. It is very convenient when the request for updating is made by the user but is not satisfactory when the request does not originate with the user and must be complied with as quickly as possible.

Another solution is disclosed in patent application EP-A-562890, which describes a method of updating information contained in a SIM card of a GSM mobile terminal using the signaling channels, i.e. the short message service (SMS).

However, this solution has the major drawback to not be secured. In other words, the SIM card of a terminal may be updated, in an erroneous way, either by mistake, or maliciously.

A secured method of updating a terminal without requiring intervention by the user and without requiring a call connection to be set up would be advantageous.

### SUMMARY OF THE INVENTION

The invention therefore proposes a method of updating the software of a GSM or equivalent mobile telephone terminal via a base transceiver station in whose coverage area the terminal is located and using data supplied by a programming platform operating at the level of a server center to which the base transceiver station is connected in a fixed telecommunication network, in which method data for updating the terminal is transferred by a transparent exchange of SMS or equivalent mobile telephone short messages at the initiative of the programming platform and in cooperation with the server center, after reciprocal authentication of the target terminal and the platform.

In accordance with one feature of a preferred embodiment of the method of the invention, an updating exchange with a terminal includes the following operations:

an MT type agent wake-up short message is sent to said terminal and includes a header characteristic of updating and data enabling the terminal to call back the platform,

an MO type acknowledgement short message is sent to the platform by the terminal after receiving a wake-up message, the acknowledgement preferably containing the call number of the terminal and a synthetic definition of the present hardware and/or software configuration of the terminal, and

one or several successive MT type messages is/are sent to the terminal for transmission of the updating information, the transmission including the update data preceded by the update header and by the new synthetic configuration definition resulting from the update.

The invention, its features and its advantages are explained in the following description given with reference to the figures listed below.

### BRIEF DESCRIPTION OF THE DRAWINGS

FIG. 1 is a block diagram of a system for transmitting short messages by radio from a server center to mobile telephone terminals in a mobile telephone system.

FIG. 2 is a diagram showing the essential steps of an exchange in accordance with the invention for updating the software of a terminal by means of a server center and at the initiative of a programming platform.

### DETAILED DESCRIPTION OF THE PREFERRED EMBODIMENT

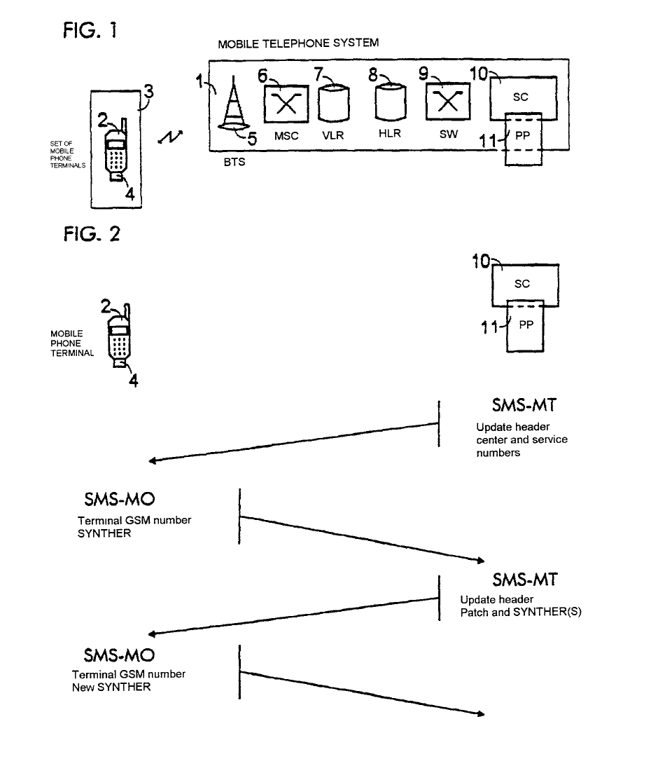

The mobile telephone system 1 shown diagrammatically in FIG. 1 is designed to set up calls between mobile radio terminals such as the mobile terminal 2 in a mobile radio network. Here the method of the invention is described in the context of a cellular mobile radio network, for example a GSM, DCS or PCS network.

The system 1 manages a network of mobile radio terminals 2, and in particular manages calls between terminals. It can also provide calls between terminals of the network and other communication terminals of other systems appropriately connected to the mobile telephone network that the system 1 manages.

The mobile telephone terminals 2 managed by the same system 1 in the context of a mobile telephone network constitute a system 3 conventionally operated by a particular service provider who uses the system 1 for operations relating to mobile telephone calls concerning the terminals 2.

Each mobile telephone terminal 2 conventionally comprises a radio transmitter-receiver, not shown, for transmitting and receiving digital or digitized signals and including a voice-data signal transmit-receive interface, a manual man-terminal control interface and a control system incorporating at least one processor and various random access memories and/or read only memories. The subsystem consisting of the memories stores some of the software required for the terminal to operate, another portion of which is conventionally stored in a memory subsystem included in a removable subscriber identification module 4 that the user must add to the terminal before it can be used. The identification module is a SIM card, for example, which when inserted can function in conjunction with the control system of the terminal.

In the context of the invention, the software and hardware features of a terminal at a particular time are translated into the form of digitized information that is stored in the terminal, i.e. in the terminal itself and/or in the associated identification module, as appropriate. The software of the terminals 2 and the identification modules 4 is written so that a terminal can transmit by radio information relating to the present hardware and/or software configuration features of the terminal. The information is combined to constitute a synthetic configuration definition (SYNTHER) which the terminal can transmit under the control of the control system of the terminal following a request received by radio from the system 1. In the embodiment of the invention described here, this configuration definition SYNTHER translates into a standardized form information which groups together the essential hardware and software features of a terminal 2. It is transmitted by SMS procedures which are not described here because they are standardized and described in various publications.

In the context of the GSM network, of which the terminal is a part, telephone calls involving a terminal 2 are effected via a base transceiver station 5 of the system 1 within radio range of which the terminal is located. Such exchanges with a terminal 2 are used in order to update the software by the method of the invention.

For such calls, the BTS 5 is part of one of the base station subsystems (BSS) of the system 1. It includes one or more radio transmitters-receivers which interface with the terminals 2 and is supervised by a base station controller (BSC) which therefore provides a first level of concentration of call circuits to one of the mobile service switching centers (MSC) 6 of a fixed communication sub-network (not shown) of the system 1.

In the case of the terminal 2 in question and for the purposes of the updating procedure, the switching center 6 concerned is that which supervises the base transceiver station 5 in whose coverage area the mobile telephone terminal 2 is located and which is responsible for the terminal 2 at the time in question. A visitor location register (VLR) database 7 associated with each switching center 6 stores data relating to terminals which are “present” in the sense that they are within the radio coverage of one of the base transceiver stations supervised by the center 6. The various subscribers of a GSM network are also listed in a home location register (HLR) 8. The register 8 stores the features of each subscriber of the network and in particular their international mobile subscriber identifying number (IMSI), their directory number and their subscription profile, and communicates with the various VLR 7 of the system in the context of procedures for determining the locations of the various terminals relative to the fixed base transceiver stations of the network.

The switching centers 6 of the system 1 are also connected to a switching center 9 having a gateway function used by a bidirectional short message service (SMS) linking the terminals to a server (SC) 10.

The server 10 has a communication facility, by means of which it is connected to the switching center 9 in particular, a control system and data storage means, in particular for storing short messages addressed to the terminals so that they can be held until the terminals are ready to receive them. This is beneficial in particular when a terminal cannot be reached, for example because it is switched off or outside the coverage area. The call is then effected as soon as the terminal manifests itself to the network one way or another.

Short messages for the terminals of the mobile telephone network can come from various sources. They conventionally include a header part in which the addressee is identified, a part for a particular volume of control data, and a part for display data intended to appear on a screen that a terminal conventionally includes.

In the case of short messages for updating the software, there is provision for intervention by a source consisting of a programming platform 11 which produces the data corresponding to the update information, for example in the usual form of a batch of data provided for at least one terminal or more generally for a plurality of similarly configured terminals.

The platform 11, which can communicate with the server 10, can be part of the system 1 or outside it, as shown in FIG. 1. It is therefore adapted to communicate with the control system and with the storage means of the server 10, either directly if it is integrated into the server or via communication means available to the server.

In accordance with the invention, and as already indicated, a terminal is updated after an exchange of data in the form of short messages between the programming platform 11 and the terminal 2 via the server 10, without requiring any intervention at the terminal by the user.

It is necessary to identify the terminal(s) for which an update is intended. This requires the hardware and/or software components of the terminals of the network which an update concerns to be listed so that the terminals which include those components, i.e. the ones which the update concerns, can be determined.

The operations for such identification are not described here in that they are only indirectly related to the object of the invention. Suffice to say that an individual identification link is defined at the level of the system 1 and allows for individual identification and location data stored in the databases 7 and the register 8 and data defining the software and hardware features for each terminal. It is conventional for the definition data relating to the terminals not to be stored in the system 1, or for not all of it to be stored, unless it is stored in the terminals themselves.

The updating method of the invention therefore implies a transparent exchange which is initiated for a terminal whose present software and hardware features have been obtained from the one(s) holding them in order to perform a verification of conformity in conjunction with the terminal where those features are also stored.

A method in accordance with the invention of transferring update data to a terminal begins by sending an agent wake-up short message to the intended destination terminal at the initiative of the programming platform 11 and via the short message server 10. The message is of the MT (module terminated) type, for example the SMS-MT type, and includes a characteristic header indicating that it concerns an update operation. The message may contain display data for showing information on the screen of the terminal to which the update relates.

The wake-up message also contains data enabling the terminal to respond with a short message of the MO (mobile originated) type, for example the SMS-MO type. This data provides the terminal with information on the origin of the message it has received, and in the present example this data corresponds to the number of the short message server 10 and that of the service at that center which identifies the programming platform 11.

The terminal authenticates the platform.

A short acknowledgement message is sent back to the server center by the terminal if the short wake-up message has been transferred successfully to the destination terminal from the server center via the base transceiver station in whose coverage area the terminal is located. The process is temporarily interrupted by the server center in the usual way if a terminal cannot be reached or if the transfer is not performed satisfactorily. It is interrupted in particular if the terminal has failed to authenticate the programming platform.

The acknowledgement message produced by a terminal contains the mobile telephone number of the terminal and the synthetic definition SYNTHER specifying its present essential hardware and software configuration features. Alternatively, only some of these features could be transmitted, if this were sufficient.

The terminal transfers the acknowledgement message to the server center 10 via the base transceiver station 5 in whose coverage area it is located. This transfer is performed transparently, without the use of the terminal by a user being effected.

One or more messages containing the update data is/are sent by the server center on receiving the acknowledgement message and after authenticating the target terminal by verifying that the configuration definition SYNTHER received from the terminal conforms to that used for the terminal on initiating the transfer. The header characteristic of update signaling is sent again to the terminal 2 in the first MT type message transmitting update data sent by the server center to the terminal. The header precedes data corresponding to all or part of the set of update data, depending on the size of the set.

Another embodiment consists in not carrying out any verification of the configuration SYNTHER, but in deciding according to it, of the opportunity of an update. So, the programming platform may have no knowledge (or partial knowledge) about the configuration of a set of mobile terminals. If one wishes to update the various versions of a software module (for example), one sends on the network a wake-up message, as previously described. The terminals answer by providing their configurations SYNTHER. According to these configurations, the platform can decide which mobile terminals need an updating, among the set of mobile terminals.

The update data is accompanied by data corresponding to the new configuration definition SYNTHER established for the terminal on the basis of the definition applying until this time and the modification(s) resulting from the update, for recording at the terminal.

In the example shown in FIG. 2, additional data is added to enable the terminal to verify that it is the intended recipient of the update message(s). This additional control data is that of the configuration definition SYNTHER previously sent by the terminal to the server center on receiving the wake-up message, for example. It is acted on and processed by the control system of the terminal, possibly in conjunction with the control system (processor and memories) of the identification module associated with the terminal at this time. The update data received in a memory of the terminal is stored for use in permanent memory of the terminal and/or the identification module associated with the terminal at this time if the verifications are effected satisfactorily.

In an embodiment also shown in FIG. 2, an update acknowledgement short message is transmitted by the terminal to the server center 10 after verification by the terminal is successful. This MO type message here includes data corresponding to the calling number of the terminal and the new configuration definition SYNTHER just received from the server center via the terminal.

If any transmission step of the update method of the invention is not performed satisfactorily and may cause an error in the terminal, the identification module associated with the terminal or the server center and/or the programming platform concerned, the intended modifications are not effected and the data corresponding to the situation preceding the update attempt is retained until another update attempt has succeeded.

Completion of updating of a particular terminal is reported to the user by display of appropriate information on the screen of the terminal, if necessary.

Use of the update method to the benefit of mobile telephone terminals of a network generally requires only additional programming at the level of the respective software means of the terminals to assure use of the short message transmission procedure as the varied steps of the method proceed. The hardware structure of a terminal 2 is therefore not described here because it is entirely conventional and is therefore well known to the skilled person.

At least one agent is provided at the level of the terminal for identifying the characteristic code of an update header in a short message and for controlling the operations performed by the terminal to enable the steps of the update process to be performed.

There is claimed:

1. A method of updating the software of a GSM or equivalent mobile telephone terminal via a base transceiver station in whose coverage area said terminal is located and using data supplied by a programming platform operating at the level of a server center to which said base transceiver station is connected in a telecommunication network, data for updating said terminal being transferred by an exchange of mobile telephone short messages, e.g. SMS, at the initiative of the programming platform and in cooperation with said server center, in which method said exchange of mobile telephone short messages comprises prior messages for reciprocal authentication of said terminal and said platform.

2. The method claimed in claim 1 wherein an exchange for updating a terminal includes the following operations:
sending said terminal an MT type agent wake-up short message which includes a header characteristic of updating and data for said terminal to call back said platform,
said terminal sending said platform an MO type acknowledgement short message after receiving a wake-up message, said acknowledgement preferably containing the call number of said terminal and a synthetic definition of the present hardware and/or software configuration of said terminal, and
sending the terminal one or several successive MT type messages for transmission of the updating information, said transmission including said update data preceded by said update header and by the new synthetic configuration definition resulting from the update.

3. The method claimed in claim 2 wherein the data transmitted by said platform to said terminal for an update also includes said synthetic configuration definition received from said terminal.

4. The method claimed in claim 1 wherein said terminal sends an MO type update acknowledgement message after the update and this message preferably includes the call number of said terminal accompanied by the new synthetic configuration definition received in the context of the update.

5. A GSM or equivalent type mobile radio terminal including software for implementing a method as claimed in any of claims 1 to 4.
